(19) United States
(12) Patent Application Publication
(10) Pub. No.: US 2018/0194015 A1
(43) Pub. Date: Jul. 12, 2018

(54) AUTOMATED PART POSITIONER

(71) Applicant: Tech Rim Standards, LLC, Rochester Hills, MI (US)

(72) Inventors: TODD M. CLEES, GRAND BLANC, MI (US); MAREK P. BIECIUK, SHELBY TWP., MI (US)

(21) Appl. No.: 15/400,134

(22) Filed: Jan. 6, 2017

(51) Int. Cl. B25J 17/00; B25J 11/00

(52) U.S. Cl. CPC B25J 17/00; Y10S 901/28; B25J 11/005

(57) ABSTRACT

A number of variations may include a work arm comprising: a first base component having a first mounting surface; a second base component having a second mounting surface, wherein the first base component and the second base component are perpendicular to each other; a first side component which is perpendicular to a first side of the first base component and the second base component; a second side component which is perpendicular to a second side of the first base component and the second base component; and wherein the first side component and the second side component are constructed and arranged to attach to an actuator.

### TECHNICAL FIELD

The field to which the disclosure generally relates to includes automated work devices.

### BACKGROUND

An automated work device may include a part positioner.

### SUMMARY OF ILLUSTRATIVE VARIATIONS

A number of variations may include a work arm comprising: a first base component having a first mounting surface; a second base component having a second mounting surface, wherein the first base component and the second base component are perpendicular to each other; a first side component which is perpendicular to a first side of the first base component and the second base component; a second side component which is perpendicular to a second side of the first base component and the second base component; and wherein the first side component and the second side component are constructed and arranged to attach to an actuator.

A number of variations may include a work arm comprising: a first base plate and a second base plate, wherein the first base plate is perpendicular to the second base plate, wherein the first base plate includes at least one first opening defined by an inner surface of the first base plate and wherein the second base plate includes at least one second opening defined by an inner surface of the second base plate; a first side plate which extends perpendicularly from a first side of the first base plate and the second base plate; a second side plate which extends perpendicularly from a second side opposite of the first side of the first base plate and the second base plate; and wherein the first side plate and the second side plate are constructed and arranged to attach to a shaft.

A number of variations may include an automated part positioner comprising: an actuator having a shaft; a work arm having a first base plate, a second base plate perpendicular to the first base plate, a first side plate attached to a first side end of the first base plate and the second base plate and a second side plate attached to a second side end of the first base plate and the second base plate; and wherein the first side plate and the second side plate are attached to the shaft and rotate with the shaft.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a perspective view of an automated part positioner according to a number of variations.

FIG. 2 illustrates a perspective close-up view of a work arm of an automated part positioner according to a number of variations.

FIG. 3 illustrates a perspective close-up view of a work arm of an automated part positioner with portions removed according to a number of variations.

FIG. 4 illustrates a perspective close-up view of a work arm of an automated part positioner according to a number of variations.

FIG. 5 illustrates a close-up side view of a work arm of an automated part positioner according to a number of variations.

FIG. 6 illustrates a close-up front view of a work arm of an automated part positioner according to a number of variations.

FIG. 7 illustrates a close-up rear view of a work arm of an automated part positioner according to a number of variations.

### DETAILED DESCRIPTION OF ILLUSTRATIVE VARIATIONS

The following description of the variations is merely illustrative in nature and is in no way intended to limit the scope of the invention, its application, or uses.

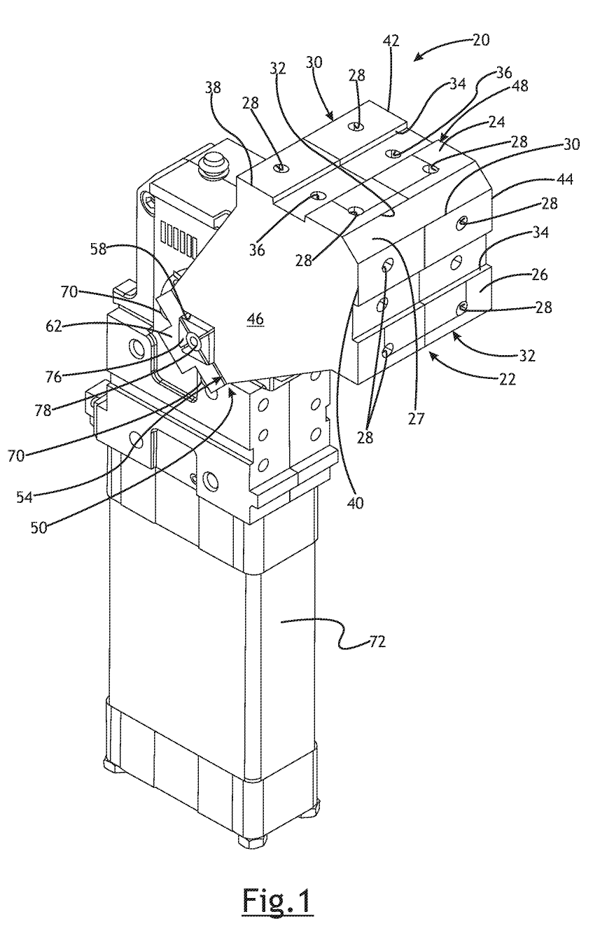

Referring to FIG. 1, in a number of variations, an automated part positioner 20 may comprise a work arm 22 which may be operatively attached to an actuator 72. In a number of variations, the work arm 22 may comprise a first base plate 24, a second base plate 26, a first side plate 46, and a second side plate 48. The first base plate 24 may be perpendicular to the second base plate 26. An intermediate surface 27 may extend between a bottom edge 32 of the first base plate 24 and a top edge 30 of the second base plate 26. The first side plate 46 and the second side plate 48 may extend perpendicularly in the same direction from opposing side edges 38, 40, 42, 44 of the first base plate 24 and the second base plate 26. The first base plate 24, the second base plate 26, the first side plate 46, and the second side plate 48 may be one single continuous component or may comprise separate pieces attached together in any number of variations including, but not limited to, one or more mechanical fasteners and/or welding.

Referring again to FIG. 1, in a number of variations, the first base plate 24 and the second base plate 26 may be constructed and arranged to act as mounting surfaces for one or more components including, but not limited to, one or more tools and/or products. The first and second base plates 24, 26 may each include at least one mounting hole 28 defined by an inner surface of the base plate 24, 26. The at least one mounting hole 28 may be constructed and arranged to accommodate at least one mechanical fastener which may be used to attach the at least one component to the first and/or second base plate 24, 26. In one variation, the at least one mounting hole 28 may be a cylindrical through-hole. In another variation, the at least one mounting hole 28 may be a threaded cylindrical through-hole. In a number of variations, the at least one mounting hole 28 may comprise a plurality of mounting holes 28 which may extend adjacent the top edge 30 and the bottom edge 32 of each of the first base plate 24 and the second base plate 26.

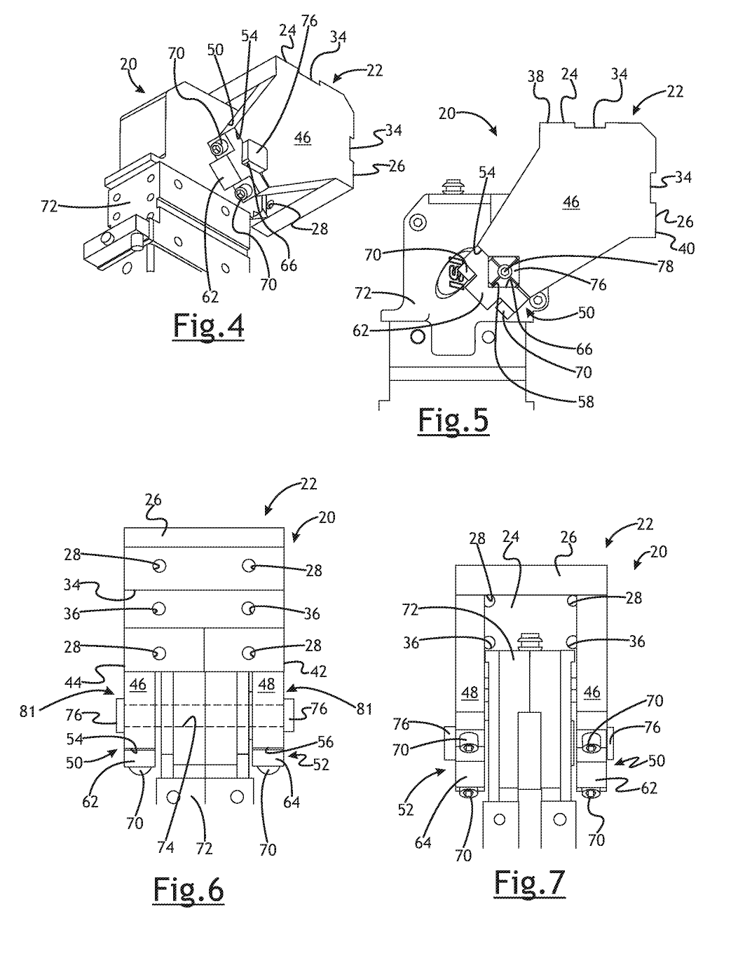

Referring to FIGS. 1-5, in a number of variations, the first base plate 24 and the second base plate 26 may each also include at least one cutout 34 defined by a first, second, and third surface of the base plate 24, 26 which may act as a keyway constructed and arranged to mate with a key on the component which may be attached to the work arm 22. The keyway 34 may assist in the positioning of the component onto the work arm 22. In one variation, the cutout 34 may extend across one or both of the first and the second base plates 24, 26 at approximately the center of the first and the second base plates 24, 26.

Referring to FIG. 1, in a number of variations, the first base plate 24 and the second base plate 26 may each also include one or more locating holes 36 defined by an inner surface of the base plate 24, 26 which may be constructed and arranged to accommodate one or more dowels which may further assist in locating and positioning a component onto the work arm 22. In a number of variations, the one or more locating holes 36 may extend through the first base plate 24 and/or the second base plate 26 within the cutouts 34.

Referring to FIGS. 1-7, in a number of variations, the first side plate 46 may extend perpendicularly in a first direction from a first side edge 38 of the first base plate 24 and a first side edge 40 of the second base plate 26. The second side plate 48 may extend perpendicularly in the first direction from a second side edge 42 of the first base plate 24 and a second side edge 44 of the second base plate 26. The first side plate 46 and the second side plate 48 may be symmetrical and may each taper as they extend away from the first side edges 38, 40 and the second side edges 42, 44 of the first and second base plates 24, 26.

In a number of variations, the first and second side plates 46, 48 may be attached to an actuator shaft 74 with a first end piece 62 and a second end piece 64, respectively, variations of which are illustrated in FIGS. 6-7. The end pieces 62, 64 may be any number of configurations including, but not limited to, a T-shape.

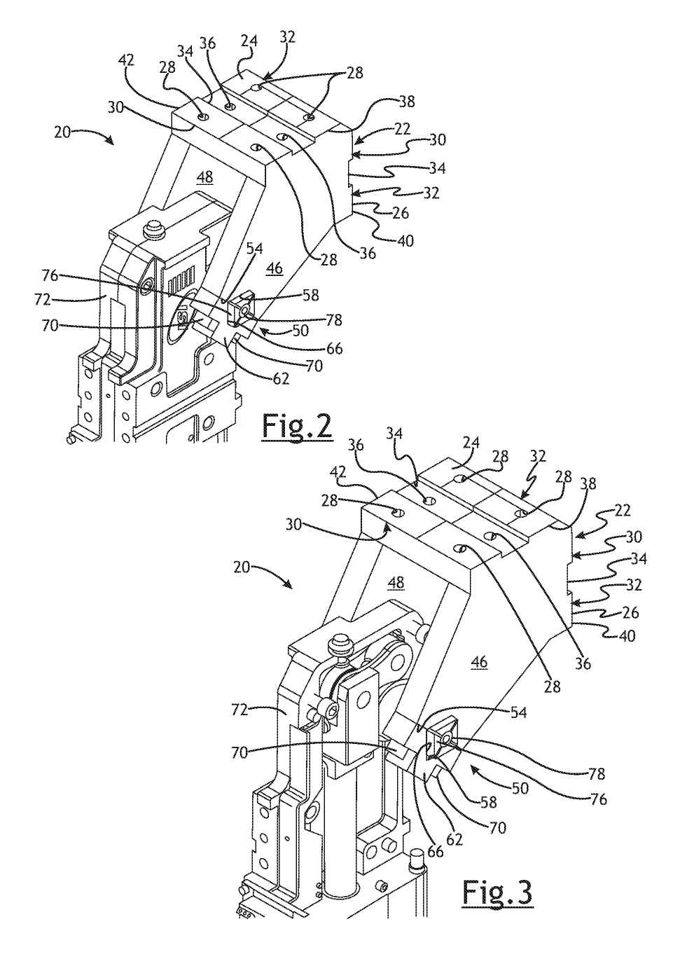

Referring to FIGS. 2-3, in a number of variations, a first end 50 of the first side plate 46 may include a first end face 54 which may include a cutout 58 defined by a surface of the first end face 54 which may be constructed and arranged to operatively attach to the shaft 74, as will be discussed hereafter. In a number of variations, the first end piece 62 may also include a cutout 66 which may align with the cutout 58 on the end face 54 of the first side plate 46 and which may also be constructed and arranged to operatively attach to the shaft 74, as will be discussed hereafter. Referring to FIG. 6, in a number of variations, a first end 52 of the second side plate 48 may also include a first end face 56 which may include a cutout (not illustrated) defined by a surface of the first end face 56 which may be constructed and arranged to operatively attach to the shaft 74, as will be discussed hereafter. In a number of variations, the second end piece 64 may also include a cutout (not illustrated) which may align with the cutout on the end face 56 of the second side plate 48 and which may also be constructed and arranged to operatively attach to the actuator shaft 74. In a number of variations, the cutouts 58, 66 on the first side plate 46 and the first end piece 62 and/or the cutouts on the second side plate 48 and the second end piece 64 may be non-cylindrical including, but not limited to, a triangle, to mate with a non-cylindrical component 76 which may be attached to one or both ends 81 of the shaft 74 and which may rotate with the shaft 74, a variation of which is illustrated in FIG. 6. This may allow the work arm 22 to also rotate with the shaft 74, as will be discussed hereafter. The non-cylindrical component(s) 76 may be attached to the shaft 74 in any number of variations including, but not limited to, a mechanical fastener 78, a variation of which is illustrated in FIGS. 1-3 and 5. The non-cylindrical component(s) 76 may be any number of non-cylindrical shapes including, but not limited to, a square.

In another variation, the cutouts 58, 66 on the first side plate 46 and first end piece 62 or the cutouts on the second side plate 48 and second end piece 64 may be cylindrical to accommodate a portion of the shaft 74 without a non-cylindrical component 76 so that only one side may be constructed and arranged to accommodate a non-cylindrical component 76.

In a number of variations, the first side plate 46 may be attached to the at least one non-cylindrical component 76 with the first end piece 62 so that the cutout 58 in the first side plate 46 and the cutout 66 in the first end piece 62 surround the at least one non-cylindrical component 76 (or shaft 74). The second side plate 48 may be attached to the at least one non-cylindrical component 76 with the second end piece 64 so that the cutout in the second side plate 48 and the cutout in the second end piece 64 surround the at least one non-cylindrical component 76 (or shaft 74). The end pieces 62, 64 may be attached to the end faces 54, 56 of the first and second side plates 46, 48 in any number of variations including, but not limited to, one or more mechanical fasteners 70. The use of an end piece 62, 64 may allow for quick and simple removal of the work arm 22 from the actuator 72.

The work arm 22 may comprise any number of metallic materials including, but not limited to, 4140 alloy steel.

In a number of variations, the actuator 72 may be constructed and arranged to rotate the shaft 74 between a first position and a second position which may cause the work arm 22 to rotate between a first position and a second position. Any number of rotational ranges between the first position and the second position may be used including, but not limited to, 120 degrees. The actuator 72 may also allow for controlled increments of rotation of the work arm 22 including, but not limited to, 15 degrees. Any number of actuators 72 may be used including, but not limited to, an electric, pneumatic, or hydraulic actuator.

In a number of variations, the above work arm 22 having two mounting surfaces may allow for attachment of components onto two separate axis at the same time which may allow for multiple assembly processes to occur using a single work arm 22. Further, the mounting holes 28, locating/dowel holes 36, and one or more keyways 34 on the first and second base plates 24, 26 may allow for positioning and attachment of complicated tooling or components which may allow for expanded use of the work arm 22 on a wide range of applications.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a work arm comprising: a first base component having a first mounting surface; a second base component having a second mounting surface, wherein the first base component and the second base component are perpendicular to each other; a first side component which is perpendicular to a first side of the first base component and the second base component; a second side component which is perpendicular to a second side of the first base component and the second base component; and wherein the first side component and the second side component are constructed and arranged to attach to an actuator.

Variation 2 may include a work arm as set forth in Variation 1 wherein at least one of the first base plate or the second base plate includes at least one keyway.

Variation 3 may include a work arm as set forth in Variation 2 further comprising the actuator, and wherein the actuator comprises an actuator shaft, and wherein the first side plate is attached to a first end of the actuator shaft and wherein the second side plate is attached to a second end of the actuator shaft and wherein the work arm rotates with the shaft.

Variation 4 may include a work arm as set forth in Variation 3 wherein at least one of the first end of the shaft or the second end of the shaft includes a non-cylindrical component.

Variation 5 may include a work arm comprising: a first base plate and a second base plate, wherein the first base plate is perpendicular to the second base plate, wherein the first base plate includes at least one first opening defined by an inner surface of the first base plate and wherein the second base plate includes at least one second opening defined by an inner surface of the second base plate; a first side plate which extends perpendicularly from a first side of the first base plate and the second base plate; a second side plate which extends perpendicularly from a second side opposite of the first side of the first base plate and the second base plate; and wherein the first side plate and the second side plate are constructed and arranged to attach to a shaft.

Variation 6 may include a work arm as set forth in Variation 5 wherein at least one of the first base plate or the second base plate includes at least one keyway.

Variation 7 may include a work arm as set forth in Variation 6 wherein the keyway further comprises at least one through-hole.

Variation 8 may include a work arm as set forth in any of Variations 5-7 wherein the at least one first opening comprises a plurality of through-holes defined by an inner surface of the first base plate which extend along a first top end and a first bottom end of the first base plate and the at least one second opening comprises a plurality of through-holes defined by an inner surface of the second base plate which extend along a second top end and a second bottom end of the second base plate.

Variation 9 may include a work arm as set forth in any of Variations 5-8 wherein the first side plate includes a first non-cylindrical cutout defined by a surface of the first side plate and the second side plate includes a second non-cylindrical cutout defined by a surface of the second side plate.

Variation 10 may include a work arm as set forth in any of Variations 5-9 further comprising a first end piece and a second end piece, wherein the first end piece includes a third non-cylindrical cutout and the second end piece includes a fourth non-cylindrical cutout, and wherein the first end piece attaches to the first side plate and the second end piece attaches to the second side plate.

Variation 11 may include a work arm as set forth in Variation 10 wherein the first end piece is attached to the first side plate via at least one mechanical fastener and the second end piece is attached to the second side plate via at least one mechanical fastener.

Variation 12 may include a work arm as set forth in any of Variations 5-11 wherein the work arm comprises a metallic material.

Variation 13 may include a work arm as set forth in any of Variations 5-12 further comprising an actuator having a shaft, and wherein the work arm is attached to the shaft, and wherein the actuator is constructed and arranged to rotate the work arm between a first position and a second position.

Variation 14 may include a work arm as set forth in Variation 13 wherein the actuator further comprises at least one non-cylindrical component attached to the shaft and which rotates with the shaft, and wherein at least one of the first side plate or the second side plate is attached to the at least one non-cylindrical component and rotates with the at least one non-cylindrical component.

Variation 15 may include an automated part positioner comprising: an actuator having a shaft; a work arm having a first base plate, a second base plate perpendicular to the first base plate, a first side plate attached to a first side end of the first base plate and the second base plate and a second side plate attached to a second side end of the first base plate and the second base plate; and wherein the first side plate and the second side plate are attached to the shaft and rotate with the shaft.

Variation 16 may include an automated part positioner as set forth in Variation 15 wherein the first base plate includes at least one first mounting hole adjacent a top end of the first base plate and at least one second mounting hole adjacent a second end opposite of the first end of the first base plate and wherein the second base plate includes at least one third mounting hole adjacent a first end of the second base plate and at least one mounting hole adjacent a second end opposite of the first end of the second base plate.

Variation 17 may include an automated part positioner as set forth in any of Variations 15-16 wherein at least one of the first base plate or the second base plate includes a keyway.

Variation 18 may include an automated part positioner as set forth in Variation 17 wherein the keyway includes at least one through-hole.

Variation 19 may include an automated part positioner as set forth in any of Variations 15-18 wherein the first side plate comprises a first body and a first end piece, wherein the first body includes a first cutout defined by a surface of the first body and the first end piece includes a second cutout defined by a surface of the first end piece and wherein the second side plate comprises a second body and a second end piece, wherein the second body includes a third cutout defined by a surface of the second body and the second end piece includes a fourth cutout defined by a surface of the second end piece; and wherein the shaft extends through the first cutout, the second cutout, the third cutout, and the fourth cutout.

Variation 20 may include an automated part positioner as set forth in any of Variations 15-19 further comprising at least one non-cylindrical component attached to the shaft so that the non-cylindrical component rotates with the shaft, wherein the first cutout, the second cutout, the third cutout, and the fourth cutout are non-cylindrical, and wherein the non-cylindrical component extends within at least one of the first cutout and the third cutout or the second cutout and the fourth cutout.

The above description of select variations within the scope of the invention is merely illustrative in nature and, thus, variations or variants thereof are not to be regarded as a departure from the spirit and scope of the invention.

What is claimed is:

1. A work arm comprising:
a first base component having a first mounting surface;
a second base component having a second mounting surface, wherein the first base component and the second base component are perpendicular to each other;
a first side component which is perpendicular to a first side of the first base component and the second base component;
a second side component which is perpendicular to a second side of the first base component and the second base component; and
wherein the first side component and the second side component are constructed and arranged to attach to an actuator.

2. The work arm of claim 1 wherein at least one of the first base plate or the second base plate includes at least one keyway.

3. The work arm of claim 1 further comprising the actuator, and wherein the actuator comprises an actuator shaft, and wherein the first side plate is attached to a first end of the actuator shaft and wherein the second side plate is attached to a second end of the actuator shaft and wherein the work arm rotates with the shaft.

4. The work arm of claim 3 wherein at least one of the first end of the shaft or the second end of the shaft includes a non-cylindrical component.

5. A work arm comprising:
a first base plate and a second base plate, wherein the first base plate is perpendicular to the second base plate, wherein the first base plate includes at least one first opening defined by an inner surface of the first base plate and wherein the second base plate includes at least one second opening defined by an inner surface of the second base plate;
a first side plate which extends perpendicularly from a first side of the first base plate and the second base plate;
a second side plate which extends perpendicularly from a second side opposite of the first side of the first base plate and the second base plate; and
wherein the first side plate and the second side plate are constructed and arranged to attach to a shaft.

6. The work arm of claim 5 wherein at least one of the first base plate or the second base plate includes at least one keyway.

7. The work arm of claim 6 wherein the keyway further comprises at least one through-hole.

8. The work arm of claim 5 wherein the at least one first opening comprises a plurality of through-holes defined by an inner surface of the first base plate which extend along a first top end and a first bottom end of the first base plate and the at least one second opening comprises a plurality of through-holes defined by an inner surface of the second base plate which extend along a second top end and a second bottom end of the second base plate.

9. The work arm of claim 5 wherein the first side plate includes a first non-cylindrical cutout defined by a surface of the first side plate and the second side plate includes a second non-cylindrical cutout defined by a surface of the second side plate.

10. The work arm of claim 9 further comprising a first end piece and a second end piece, wherein the first end piece includes a third non-cylindrical cutout and the second end piece includes a fourth non-cylindrical cutout, and wherein the first end piece attaches to the first side plate and the second end piece attaches to the second side plate.

11. The work arm of claim 10 wherein the first end piece is attached to the first side plate via at least one mechanical fastener and the second end piece is attached to the second side plate via at least one mechanical fastener.

12. The work arm of claim 5 wherein the work arm comprises a metallic material.

13. The work arm of claim 5 further comprising an actuator having a shaft, and wherein the work arm is attached to the shaft, and wherein the actuator is constructed and arranged to rotate the work arm between a first position and a second position.

14. The work arm of claim 13 wherein the actuator further comprises at least one non-cylindrical component attached to the shaft and which rotates with the shaft, and wherein at least one of the first side plate or the second side plate is attached to the at least one non-cylindrical component and rotates with the at least one non-cylindrical component.

15. An automated part positioner comprising:
an actuator having a shaft;
a work arm having a first base plate, a second base plate perpendicular to the first base plate, a first side plate attached to a first side end of the first base plate and the second base plate and a second side plate attached to a second side end of the first base plate and the second base plate; and
wherein the first side plate and the second side plate are attached to the shaft and rotate with the shaft.

16. The automated part positioner of claim 15 wherein the first base plate includes at least one first mounting hole adjacent a top end of the first base plate and at least one second mounting hole adjacent a second end opposite of the first end of the first base plate and wherein the second base plate includes at least one third mounting hole adjacent a first end of the second base plate and at least one mounting hole adjacent a second end opposite of the first end of the second base plate.

17. The automated part positioner of claim 15 wherein at least one of the first base plate or the second base plate includes a keyway.

18. The automated part position of claim 17 wherein the keyway includes at least one through-hole.

19. The automated part positioner of claim 15 wherein the first side plate comprises a first body and a first end piece, wherein the first body includes a first cutout defined by a surface of the first body and the first end piece includes a second cutout defined by a surface of the first end piece and wherein the second side plate comprises a second body and a second end piece, wherein the second body includes a third cutout defined by a surface of the second body and the second end piece includes a fourth cutout defined by a surface of the second end piece; and wherein the shaft extends through the first cutout, the second cutout, the third cutout, and the fourth cutout.

20. The automated part positioner of claim 15 further comprising at least one non-cylindrical component attached to the shaft so that the non-cylindrical component rotates with the shaft, wherein the first cutout, the second cutout, the third cutout, and the fourth cutout are non-cylindrical, and wherein the non-cylindrical component extends within at least one of the first cutout and the third cutout or the second cutout and the fourth cutout.
